(19) United States
(12) Patent Application Publication
(10) Pub. No.: US 2011/0177350 A1
(43) Pub. Date: Jul. 21, 2011

(54) SCRATCH- AND WEAR-RESISTANT COATING ON POLYMER SURFACES WITH CATALYTICALLY ACCELERATED HARDENING

(75) Inventors: Heike Bergandt, Marl (DE); Helmut Fobbe, Iserlohn (DE); Peter Meisterjahn, Iserlohn (DE); Christian Roloff, Schwerte (DE)

(73) Assignee: EVONIK DEGUSSA GMBH, ESSEN (DE)

(21) Appl. No.: 13/002,622

(22) PCT Filed: May 11, 2009
(86) PCT No.: PCT/EP2009/055672

§ 371 Date: Mar. 28, 2011

(30) Foreign Application Priority Data
Jul. 4, 2008 (DE) 10 2008 040 162.5

(51) Int. Cl. B32B 9/04; C09D 7/00; B05D 3/10; C08J 7/18

(52) U.S. Cl. 428/447; 106/287.11; 427/387; 427/515

(57) ABSTRACT

A coating system, comprising components A and B, wherein component A contains at least one reaction product of a silane Y⁽¹⁾SiOR₁OR₂OR₃ where Y⁽¹⁾ is a 3-glycidyloxypropyl group and similar or dissimilar alkyl groups R₁, R₂, R₃ with 1 to 6 carbon atoms and water in the presence of a catalyst, and component B contains at least one reaction product of a further silane Y⁽²⁾SiOR′₁OR′₂OR′₃ wherein Y⁽²⁾ is a N-2-aminoethyl-3-aminopropyl- or NH₂(CH₂)₂NH(CH₂)₂NH(CH)₃ group and similar or dissimilar alkyl groups R′₁, R′₂, R′₃ with 1 to 6 carbon atoms in the presence of an adjunct selected from ammonium compounds or hydroxides and at least one of the components A, B contains additionally at least one inorganic filler and a solvent with a boiling point of ≦85° C. Also, a method for producing a surface coating on a polymer surface, an article with at least one polymeric surface having the surface coating, and a use of the article.

The present invention relates to a coating system which forms acceleratedly drying, scratch-resistant, hard surface coatings by way of the sol-gel technology on a wide variety of polymers, and also to a method for producing such surface coatings.

The production of glasslike coatings on steel or polymers is long-established and frequently described.

By scratch hardness is meant, at this point and below, the resistance of the surface coating of a material to the application of scratches, and is determined using a hardness testing rod. This rod is composed of a sleeve inserted in which is a helical spring which can be given a variety of different tensions by means of a slider. The spring force set in this way acts on a scoring pin whose tip emerges from the sleeve. The slider is fixed with a clamping screw to keep the spring tension constant. In this way, the scoring pin can be subjected to different loads, and hence the tip can be pressed with a defined force onto the surface coating.

Used in the context of the present invention is the Hardness test rod 318 from ERICHSEN GmbH & Co KG, Am Iserbach 14, D-58675 Hemer. The tip of the scoring pin is made of hard metal and is rounded to a diameter of 0.75 mm. Using the slider, an estimated or already known spring force is set on a scale along the hardness test rod, and the clamping screw is tightened. The hardness test rod is then placed vertically with the tip on the surface coating of the material, and is drawn at about 10 mm/s over a path of 5 to 10 mm in length. In the course of this procedure, pressure is exerted on the hardness test rod in such a way that the tip of the scoring pin is pressed up to the collar into the sleeve. The position of the slider at which, after the hardness test rod has been drawn over the surface coating, a visible scratch track is formed on said coating, indicates, on a scale, the measure of the measurement value which is characteristic of the hardness. This measurement value is the Weinmann scratch hardness, which in the context of the present invention is reported in N.

By abrasion resistance is meant at this point and below, the weight loss, measured in % by weight, suffered by the surface coating of a material as a result of abrasion brought about under defined conditions. This abrasion is brought about by two abrading wheels whose end faces have a defined roughness and are rubbed with a defined number of rotations, and with an application force defined by the mass of the abrading wheel, over the surface coating. The device used for this test is described and available from the company TABER INDUSTRIES (455 Bryant Street, North Tonawanda, N.Y. 14120, USA, http://www.taberindustries.com).

DE 38 28 098 A1 describes the production of scratch-resistant materials on the basis of organofunctional silanes and at least one aluminum alkoxide. A composition obtained by hydrolytic polycondensation of at least one aluminum compound and at least one organofunctional silane is applied to a substrate and cured by heating. A particular step in the production of the composition is seen as being the necessary precondensation of the composition by addition of water in a substoichiometric proportion, before the composition is applied to the substrate. The water must be added in a number of stages in order to avoid unwanted precipitation.

DE 39 17 535 A1 as well describes the production of compositions for scratch-resistant coatings on the basis of hydrolyzable silicon compounds. In addition to organofunctional silanes, use is made of aluminum, titanium and/or zirconium alkoxides. In order to achieve scratch resistance, a volatile part of the hydrolysis compounds is evaporated off. In this method, likewise, the addition of water in a substoichiometric proportion causes precondensation of the mixture of hydrolyzable silicon compounds, and this necessitates a separate method step. This precondensation can be accelerated by using a condensation catalyst. Only after the precondensation and the evaporative removal of volatile hydrolysis compounds is the composition applied to the substrate and then cured by heating for a number of minutes up to two hours.

A combination of alkoxides of Al, Ti and/or Zr with at least one organofunctional silane is described in U.S. Pat. No. 4,746,366. This combination is precondensed by stepwise addition of water. The hydrolysis products are removed from the combination under reduced pressure. The resulting product is applied to a substrate and is cured by heating for a time from a few minutes up to two hours.

Coating materials for producing abrasion-resistant protective coats on substrates made of plastic are described in DE 199 52 040 A1, DE 102 457 25 A1, DE 102 457 26 A1, and DE 102 457 29 A1. However, the coating material disclosed in these specifications has to be applied in at least two coats, namely what is called a scratch-resistant coat or base coat, and a top coat, and must be precondensed and then at least partly cured. The time for the precondensation can be shortened through the addition of a condensation accelerator. To cure the coating formed from these coats, however, still takes up times of 30-200 minutes at a temperature 110-130° C., which, although suitable for the coating of individual parts or sheet product, is still much too long for continuous film coating.

DE 40 11 045 A1 describes the production of a scratch-resistant coating material to which a commercially available photoinitiator is added. Following application to a plastics substrate, the coating material can be cured thermally or by irradiation with UV light within 120 seconds.

Common to all of these publications is the time-consuming step of precondensation for producing the coatings or coating materials. A further disadvantage of the prior art is that the coatings must be applied multiply, up to a coating thickness of more than 15 μm, in order to obtain the desired scratch or abrasion resistance. Both disadvantages render the existing coating methods and coating systems uneconomic or even impossible to use for the coating of films in a roll-to-roll process.

And yet there is a demand to provide flexible plastics surfaces with new functionalities and improved properties which can be produced in a continuous process at high belt speeds, both in the application of the coating material and in the drying/curing operation.

It was an object of the present invention to provide a coating system improved over the prior art and a method for producing scratch-resistant and abrasion-resistant coatings on polymeric surfaces that do not have one or more disadvantages of the prior art.

This object is surprisingly achieved by a coating system which, in a sol-gel operation, in addition to the condensation to form Si—O—Si bonds, also undergoes organic crosslinking, and whose cure time is drastically shortened, relative to the prior art, in the presence of a catalyst and an adjuvant.

The present invention accordingly provides a coating system comprising two components, A and B, where component A comprises at least one reaction product of the fractions
Aa) silane of the general formula

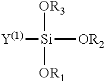

where
Y⁽¹⁾=3-glycidyloxypropyl-, and
R₁, R₂, R₃=identical or nonidentical alkyl groups having 1 to 6 carbon atoms,
and
Ab) water,
in the presence of
Ac) a catalyst selected from inorganic or organic acids,
   and component B comprises at least one reaction product of the fraction
Ba) silane of the general formula

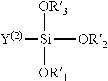

where
Y⁽²⁾=N-2-aminoethyl-3-aminopropyl- or NH₂(CH₂)₂NH(CH₂)₂NH (CH)₃ — and R′₁, R^{′}₂ , R^{′}₃=identical or nonidentical alkyl groups having 1 to 6 carbon atoms,
in the presence of
Bb) an adjuvant selected from quaternary ammonium compounds,
and at least one of components A and B further comprises the fractions
   d) at least one inorganic filler, and
   e) a solvent having a boiling point at a temperature ≦85° C.

The present invention further provides a method for producing a surface coating on a polymeric surface, which is characterized in that the fractions of components A and B of the coating system of the invention
(i) are combined, and then
(ii) the composition obtained in step (i) is stored, and then
(iii) the composition obtained in step (ii) is applied to the substrate, and then
(iv) is cured there.

The method of the invention has the advantage that the coating compositions must be applied only once to the plastics surface in order to obtain desired scratch or abrasion resistance. The coating method of the invention therefore allows the continuous production of coated plastics surfaces, such as films, for example, in a roll-to-roll process, without the need, as in the prior art, for coatings to be multiply applied or reworked.

Further provided with the present invention, therefore, is the coating obtained by the method of the invention.

Likewise provided with the present invention is a coating comprising silicon-oxygen-silicon bonds and characterized in that the coating has a Weinmann scratch hardness of 5 N to 11 N.

Also provided with the present invention is an article having at least one polymeric surface which has the coating of the invention.

The present invention also provides for the use of the article of the invention for the cladding of apparatuses, fittings, instruments, measuring instruments, sanitary installations, kitchen appliances, household appliances, vehicle interiors, cockpits, displays, viewing windows or furniture, and the use of the article of the invention as a plate, shell, shaped part, housing, button, lever, foot, door, lid, base, side walls, handle, decorative insert or splash-protection element.

An advantage of the coating system of the present invention is that the coating system does not have the undesirable gelling known from the prior art to the skilled worker, after any of steps (i)-(iii) of the method of the invention, and thus can be applied with reduced machinery cost and complexity, in thin coats.

A further advantage of the coating system of the invention is that, after the method of the invention has been implemented, the coating system cures in a time of 20 to 30 seconds. Accordingly, plastics surfaces can be coated with belt speeds that are considerably increased—doubled, for example—relative to the prior art.

In a roll-to-roll process, on a belt line or in any other continuous process, by virtue of this shorter time for curing the coating system of the invention relative to the prior art, it is possible to realize substantially higher throughput rates or production rates per unit time and hence to achieve significant reductions in the production costs of the coated product as compared with the prior art.

A further advantage of the method of the present invention is that the surface coating need be applied only a single time in order to obtain a crack-free and gapless surface coating.

A crack-free surface coating in the context of the present invention means a surface coating which shows no crack in a scanning electron microscope (SEM) image of the surface of the surface coating at a magnification of 10 000, with evaluation of ten different points on the surface.

A further advantage of the method of the invention is that, relative to the prior art, there is no blocking or postcuring of the cured coating. After curing, the product can be immediately rolled up or stacked, without surfaces in contact becoming stuck to themselves or to one another.

The method of the present invention likewise has the advantage that the measurement of the Weinmann scratch hardness on the surface coating of the invention leads to substantially better results as compared with coatings of the prior art. In the case of printed polyvinyl chloride (PVC) films to which the surface coating of the invention is applied by the method of the invention, the print remains without damage up to a Weinmann scratch hardness of 20 N. In the case of coatings applied by the prior art to printed PVC films, a force even of above 2.5 N causes damage to the print.

The coating system of the invention and the method of the invention are described by way of example below.

The present invention provides a coating system comprising two components, A and B, where component A comprises at least one reaction product of the fractions
Aa) silane of the general formula

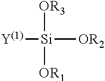

where
Y⁽¹⁾=3-glycidyloxypropyl-, and
R₁, R₂, R₃=identical or nonidentical alkyl groups having 1 to 6 carbon atoms,
and
Ab) water,
in the presence of
Ac) a catalyst selected from inorganic or organic acids,
   and component B comprises at least one reaction product of the fraction
Ba) silane of the general formula

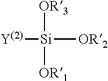

where
Y⁽²⁾=N-2-aminoethyl-3-aminopropyl- or NH₂(CH₂)₂NH(CH₂)₂NH(CH)₃— and R′₁, R′₂, R′₃ =identical or nonidentical alkyl groups having 1 to 6 carbon atoms,
in the presence of
Bb) an adjuvant selected from quaternary ammonium compounds,
and at least one of components A and B further comprises the fractions
   d) at least one inorganic filler, and
   e) a solvent having a boiling point at a temperature ≦85° C.

Preferably the fractions d) and e) may be present in B. This embodiment of the coating system of the invention has the advantage that the coating system can be stored for a long time, preferably 1 hour to 30 days, more preferably 1 day to 10 days.

It may be advantageous if the radicals R₁, R₂, R₃ and/or R′₁, R′₂, R′₃ of the coating system of the invention are identical at least in pairs.

Furthermore, it may be advantageous if at least one radical R₁, R₂, and R₃ is selected from ethoxy-, and/or at least one radical R′₁, R′₂, and R′₃ is selected from ethoxy-, if Y⁽²⁾=N-2-aminoethyl-3-aminopropyl-, or is selected from methoxy, if Y⁽²⁾=NH₂(CH₂)₂NH(CH₂)₂NH(CH)₃—.

Particular preference may be given to the selection R₁=R₂=R₃=R′₁=R′₂=R′₃=ethoxy-, additionally particular preference to the selection R₁=R₂=R₃=ethoxy-, and R′₁=R′₂=R′₃=methoxy-.

The fraction Aa) with the selection R₁=R₂=R₃=ethoxy- is referred to, at this point and below, by GLYEO; the fraction Ba) with the selection R′₁=R′₂=R′₃=ethoxy- by AMEO, and the fraction Ba) with the selection R′₁=R′₂=R′₃=methoxy- by DAMO, for N-(2-aminoethyl-3-aminopropyl)trimethoxysilane.

Preferably the fraction Ab) of the coating system of the invention may be selected from aqueous nitric acid.

With further preference the proportions of the fractions Ab) and Ac) may be selected such that 99 parts of water (for Ab)) and 1 part of catalyst (for Ac)) are used. With further preference the proportions of the fractions Aa) and Ac) may be selected such that 1000 parts of GLYEO (for Aa)) and 1 part of catalyst (for Ac)) are used. With particular preference the proportions of the fractions Ab), Ac), and Aa) may be selected such that 99 parts of water (for Ab)) and 1 part of catalyst (for Ac)) and 1000 parts of GLYEO (for Aa)) are used.

It may be advantageous if the inorganic filler, fraction d) of the coating system of the invention, is selected from SiO₂, TiO₂, ZnO, Al₂O₃, BaSO₄, CeO₂, ZrO₂, CaCO₃, or a mixture of these fillers.

Additionally it may be advantageous if the inorganic filler has an average primary particle size d₅₀ of 10-2000 nm. In the context of the present invention, primary particles are particles which are neither agglomerations nor aggregations of smaller particles. The inorganic filler may preferably comprise a mixture of primary particles and agglomerated and/or aggregated particles. With particular preference the fraction d) may consist of primary particles. With very particular preference, d) may consist of primary particles which have a primary particle size d₅₀ of 10 to 200 nm.

The adjuvant Bb) of the coating system of the invention may preferably be selected from tetraethylammonium fluoride dihydrate, tetra-n-butylammonium fluoride trihydrate, hexadecyltrimethylammonium bromide, tetraethylammonium chloride, tetraethylammonium bromide, tetraethylammonium chloride monohydrate, tetra-n-butylammonium tetrafluoroborate (99%), more preferably tetraethylammonium fluoride dihydrate, tetra-n-butylammonium fluoride trihydrate, hexadecyltrimethylammonium bromide, or a mixture of these adjuvants.

The effect of the quaternary ammonium compounds is to accelerate the ring-opening reaction on the epoxide, to increase the degree of crosslinking, and to shorten the cure time as soon as step (iv) of the method of the invention is carried out.

The fraction e) of the coating system of the invention may advantageously be selected from the series of the alcohols of the general formula CₙH₂ₙ₊₁OH, where n=1 to 4, or may be selected from a mixture of these alcohols, or may be selected from ketones selected from acetone, methyl ethyl ketone, or a mixture of these ketones, or may be selected from acetates.

With particular preference fraction e) of the coating system of the invention may be selected from ethanol, 1-propanol, 2-propanol, or a mixture of these alcohols, or may be selected from methyl ethyl ketone. This selection has the advantage that the solvent causes slight incipient dissolution of the substrate on which the coating system is applied, preferably the plastics film, and therefore improves the adhesion of the coating obtained after the method of the invention has been carried out.

At least one of components A and B of the coating system of the invention may advantageously comprise a further fraction

c) at least one reaction product of a further silane

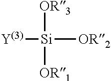

where Y⁽³⁾ is selected from alkyl-, fluoro-, fluoroalkyl-, methacryloyl-, vinyl-, mercapto-, and R″₁, R″₂, R″₃=identical or nonidentical alkyl groups having 1 to 6 carbon atoms.

The present invention further provides a method for producing a surface coating on a substrate, which is characterized in that the fractions of components A and B of the coating system of the invention
(i) are combined, and then
(ii) the composition obtained in step (i) is stored, and then
(iii) the composition obtained in step (ii) is applied to the substrate, and then
(iv) is cured there.

Preferably, in step (i) of the method of the invention, the fractions of components A and B and the fractions d) and e) may be combined in any desired order. With particular preference, in step (i), it is possible first for the fractions of component A to be combined, then for the fractions of component B to be combined, and then for components A and B to be combined, and then for the fractions d) and e) to be added. With very particular preference it is possible, in step (i), first for all of the fractions apart from Ac) and Bb), and then the fractions Ac) and Bb), to be added.

Preferably, in step (i) of the method of the invention, the components and fractions may be brought together by stirring, kneaded incorporated, by means of Scandex, static mixer, shaker, or by a combination.

It may be particularly advantageous if the components and fractions in the method of the invention are combined by stirring. With particular advantage, furthermore, in the method of the invention the components and fractions may be mixed with one another by stirring in a propeller stirrer, inclined-blade stirrer, disk stirrer, impeller stirrer, cross-arm stirrer, anchor stirrer, blade stirrer, gate stirrer, helical stirrer, toothed-disk stirrer, turbine stirrer, half-moon stirrer, or fan stirrer. With particular advantage, furthermore, it is possible in the method of the invention to use stirring techniques which introduce little ambient gas or none at all, into the composition, and/or with which little heat energy is carried into the composition. With very particular preference it is possible in the method of the invention to use propeller stirrers, inclined-blade stirrers, disk stirrers, impeller stirrers, cross-arm stirrers, anchor stirrers, blade stirrers, gate stirrers, helical stirrers, or toothed-disk stirrers, additionally with very particular preference, propeller stirrers, disk stirrers, or impeller stirrers.

It may be advantageous if, in the method of the invention, the components and fractions are combined at low shear rates over a time of 1 to 10 min, preferably of 2 to 8 min, more preferably of 3 to 7 min, very preferably of 4 to 6 min, with extraordinarily particular preference of 4.8 to 5.2 min.

Preferably, in step (ii) of the method of the invention, the composition obtained in step (i) may be stored for a time of 30 min to 2 days, more preferably of 4 hours to 1 day, under ambient temperature and with air excluded.

In step (iii) of the method of the invention, the composition obtained in step (ii) may be applied to the substrate preferably by dipping, spreading, knife coating, brushing, rolling, roll coating, reverse roll coating, kiss coating, casting, flooding or spraying, more preferably by casting or flooding in the case of sheet or strip products or films.

In the method of the invention it is possible in step (iii) for the composition obtained in step (ii) to be applied preferably to a solid substrate which is or comprises glass, fused silica, metal, stone, wood, concrete, paper, textiles or plastic. The plastic used may be, for example, polyester, polyamide, polyimide, polyacrylate, polycarbonate (PC), polyethersulfone (PES), polyetheretherketone (PEEK), polyvinyl chloride (PVC), polyethylene (PE), polypropylene (PP), polyacetal (POM), or a mixture of these polymers.

As polyester it is possible to use polyethylene terephthalate (PET), polyethylene naphthalate (PEN), polybutylene terephthalate (PBT), polyhydroxybutyrate (PHB), or a mixture of these polyesters. As polyamide it is possible to use polyamide 6, polyamide 6.6, polyamide 11, polyamide 12, or a mixture of these polyamides.

As a polyimide it is possible to use Kapton® . As a polyacrylate it is possible with preference to use polymethyl methacrylate (PMMA).

With particular preference this composition may be applied to at least one surface of a substrate which is or comprises acrylonitrile-butadiene-styrene copolymer (ABS), PVC, PET, PE, PC, PMMA, styrene-acrylonitrile copolymer (SAN), polystyrene, or a combination of these polymers or copolymers.

In step (iv) of the method of the invention, the composition applied to the substrate in step (iii) may be cured advantageously by admission of a flow of gas or air, preferably ambient air, and/or by irradiation with electromagnetic energy. The relative atmospheric humidity may be preferably from 10% to 99%, more preferably from 50% to 98%, very preferably from 70% to 97%, and with extraordinary preference from 80% to 95%.

The applied coat may preferably be dried until there is no longer any change in the weight of the substrate with the applied coat or coats. The applied coat may preferably be dried in an oven. With particular preference the applied coat may be dried by admission of a flow of heated gas or heated air.

Curing may also take place by irradiation with electromagnetic energy, preferably microwaves, or IR radiation.

It may further be advantageous to repeat steps (i)-(iv) of the method of the invention at least once.

In the method of the invention it may further be advantageous if in step (iv) the electromagnetic energy is used with irradiation times of 1 s to 60 s, preferably of 2 s to 50 s, more preferably of 5 s to 10 s. The irradiation time may be realized preferably by switching on and off the energy source, additionally, preferably, by opening and closing of a shutter mounted ahead of the emission aperture of the energy source. In the method of the invention, the composition applied in the form of a coat may be irradiated preferably from once to 50 times, more preferably from twice to 5 times or 5 times to 10 times, with electromagnetic energy.

If irradiation with electromagnetic energy is used more than once in the method of the invention, it may further be advantageous if the durations of the irradiations with electromagnetic energy, and each combination of the durations, are identical or nonidentical. It may further be advantageous if the radiation outputs, and each combination of the radiation outputs, are identical or nonidentical. In the method of the invention it may further be advantageous if the wavelengths, and each combination of the wavelengths, and frequencies, and each combination of frequencies, are identical or nonidentical.

If microwaves are used in step (iv) of the method of the invention, it may further be advantageous if identical and/or nonidentical frequencies of 550 MHz to 25 GHz, preferably from 750 MHz to 15 GHz, more preferably from 900 MHz to 12 GHz, additionally more preferably of 1.2 GHz to 10.5 GHz are used, and with very particular preference if frequencies are used which are ISM frequencies.

If IR radiation is used in step (iv) of the method of the invention, it may be advantageous to use wavelengths of 1 to 5000 μm, preferably 2 to 2000 μm, more preferably 5 to 1000 μm. With very particular preference it is possible to use IR radiation generated by halogen lamps.

If steps (i)-(iv) are repeated more than once in the method of the invention, it may be advantageous, after carrying out step (iii), to wait for a time of 1-30 s, preferably of 10-20 s, with the implementation of step (iv).

In another embodiment of the method of the invention, step (iv) may be carried out by passing the substrate with the composition through a spatially delimited area, in which the electromagnetic energy is irradiated, at a defined speed. In the method of the invention it is further preferred if the substrate with the composition of the invention is guided, in a roll-to-roll operation, through the spatially delimited area irradiated with electromagnetic energy.

In the method of the invention it may further be advantageous if identical and/or nonidentical outputs of 50 W to 50 kW, preferably of 250 W to 25 kW, more preferably of 500 W to 15 kW are used.

In the method of the invention it is possible with preference in step (iv) to heat the composition to a temperature of 60° C. to 150° C., as a result of which the composition is cured.

In the method of the invention it is possible in step (iv) to cure the composition by heating for a time of 1 to 60 s, more preferably of 5 to 10 s.

It may be advantageous in the method of the invention, in component A, if the fraction
Aa) is used with a weight fraction of 5% to 40% by weight, and
Ab) is used with a weight fraction of 5% to 20% by weight, and
Ac) is used with a weight fraction of 0.05% to 1.5% by weight,
and, in component B, the fraction
Ba) is used with a weight fraction of 5% to 50% by weight, and
Bb) is used with a weight fraction of 0.4% to 2% by weight,
and, in at least one of components A and B, the fraction
d) is used with a weight fraction of 2% to 20% by weight, and
e) is used with a weight fraction of 2% to 60% by weight,
   the quantitative indication being based in each case on the coating system, and with the proviso that the sum of the weight fractions taken together makes 100%.

If the adjuvant Bb) is selected from tetraethylammonium chloride, tetraethylammonium bromide, tetraethylammonium chloride monohydrate, tetra-n-butylammonium tetrafluoroborate (99%), or a mixture of these adjuvants, it may be advantageous, in the method of the invention, to use said adjuvant or adjuvants with a weight fraction of 0.5% to 1.5% by weight, preferably of 1% to 1.5% by weight, the quantitative indication being based in each case on the coating system, and with the proviso that the sum of the weight fractions in the components taken together makes 100%.

If the adjuvant Bb) is selected from tetraethylammonium fluoride dihydrate, it may be advantageous, in the method of the invention, to use said adjuvant with a weight fraction of 1.3% to 1.75% by weight, preferably of 1.4% to 1.6% by weight, more preferably of 1.5% to 1.55% by weight, very preferably 1.54% by weight, the quantitative indication being based in each case on the coating system, and with the proviso that the sum of the weight fractions in the components taken together makes 100%.

If the adjuvant Bb) is selected from tetra-n-butylammonium fluoride trihydrate, it may be advantageous, in the method of the invention, to use said adjuvant with a weight fraction of 1.3% to 1.75% by weight, preferably of 1.4% to 1.6% by weight, very preferably 1.5% by weight, the quantitative indication being based in each case on the coating system, and with the proviso that the sum of the weight fractions in the components taken together makes 100%.

If the adjuvant Bb) is selected from hexadecyltrimethylammonium bromide, it may be advantageous, in the method of the invention, to use said adjuvant with a weight fraction of 0.75% to 1.25% by weight, preferably of 0.9% to 1.1% by weight, very preferably 1.0% by weight, the quantitative indication being based in each case on the coating system, and with the proviso that the sum of the weight fractions in the components taken together makes 100%.

In the method of the invention it may be advantageous if the fractions Aa) and Ba) are used in a molar ratio of 1:3 to 3:1.

Furthermore, in the method of the invention, it may be advantageous if at least one of the components A and B is admixed with the fraction c) with a weight fraction of 0.5% to 10% by weight, the quantitative indication being based on the coating system, and with the proviso that the sum of the weight fractions taken together makes 100%.

Furthermore, in the method of the invention, it may be advantageous if at least one of components A and B is admixed with, as further fractions,
f) film-forming binder selected from melamine resin, acrylate or a mixture of these film-forming binders, with a weight fraction of 0.001% to 15% by weight, and/or
g) epoxy resin with a weight fraction of 0.001% to 15% by weight,
   the quantitative indication being based in each case on the coating system, and with the proviso that the sum of the weight fractions taken together makes 100%.

Furthermore, in the method of the invention, it may be advantageous if at least one of components A and B is admixed with, as a further fraction,
h) an inorganic UV absorber selected from zinc oxide, cerium oxide or titanium dioxide, or a mixture of these inorganic absorbers, and/or an organic UV absorber selected from hydroxyphenylbenzotriazole, hydroxybenzophenone, HALS stabilizers, or a mixture of these organic absorbers
   and in step (iv) the composition is treated with UV rays.

The fraction h) in the method of the invention may be used preferably with a weight fraction of 0.5% to 5% by weight, the quantitative indication being based on the coating system, and with the proviso that the sum of the weight fractions taken together makes 100%.

The present invention also provides a coating which comprises silicon-oxygen-silicon bonds and which is characterized in that the coating has a Weinmann scratch hardness of 5 to 20 N.

Preferably this coating may have a scratch hardness of 6 to 10 N, more preferably of 6 to 7 N, with additional particular preference of 7 to 8 N, with additional particular preference of 8 to 9 N, with additional particular preference of 7 to 10 N, and with additional particular preference of 9 to 10 N.

The coating of the invention may have an abrasion resistance of 0.1% to 0.5% by weight.

The coating of the invention may preferably have a coat thickness of 1-10 μm. By coat thickness is meant the thickness of the coat obtained after step (iv) of the method of the invention.

It may be advantageous if the coating of the invention comprises an inorganic filler in the form of particles which have a homogeneous distribution.

The coating of the invention may additionally have an extensibility of 0.5% to 10%.

The coating of the invention preferably features thermal weldability. This provides the advantage that the coating of the invention is not damaged, and certainly not lost, even in the case of semifinished product which is to be processed further by welding techniques or other heat-introducing fusion techniques or joining techniques.

Also provided by the present invention, accordingly, is an article having at least one polymeric surface which has the coating of the invention.

The article of the invention may be selected preferably from sheet product, strip product, film, or an individual part, more preferably a film.

The polymeric surface of the article of the invention may further be selected from acrylonitrile-butadiene-styrene copolymer (ABS), PVC, PET, PE, PC, PMMA, styrene-acrylonitrile copolymer (SAN), polystyrene, or a combination of these polymeric surfaces.

The present invention likewise provides for the use of the article of the invention for the cladding of apparatuses, fittings, instruments, measuring instruments, sanitary installations, kitchen appliances, household appliances, vehicle interiors, cockpits, displays, viewing windows or furniture, and the use of the article of the invention as a plate, shell, shaped part, housing, button, lever, foot, door, lid, base, side walls, handle, decorative insert or splash-protection element.

1. A coating system, comprising component A and component B, wherein component A comprises at least one reaction product of
Aa) a silane of formula (I) 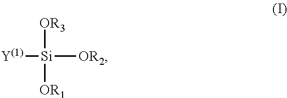
wherein
Y⁽¹⁾ is 3-glycidyloxypropyl-, and
R₁, R₂, and R₃ are identical or nonidentical alkyl groups having 1 to 6 carbon atoms, and
Ab) water, in the presence of
Ac) at least one catalyst selected from the group consisting of an inorganic acid and an organic acid,
and component B comprises at least one reaction product of
Ba) a silane of formula (II) 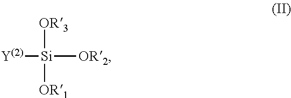
wherein
Y⁽²⁾ is N-2-aminoethyl-3-aminopropyl- or NH₂(CH₂)₂NH(CH₂)₂NH(CH)₃—, and
R′₁, R′₂, and R′₃ are identical or nonidentical alkyl groups having 1 to 6 carbon atoms, in the presence of
Bb) at least one adjuvant which is a quaternary ammonium compound,
and at least one of components A and B further comprises
d) at least one inorganic filler, and
e) a solvent having a boiling point at a temperature ≦85° C.

2. The coating system of claim 1, wherein
at least one radical from R₁, R₂, and R₃ is ethoxy-, and/or
at least one radical from R′₁, R′₂, and R′₃ is ethoxy-, if Y⁽²⁾ is N-2-aminoethyl-3-aminopropyl-, or is methoxy, if Y⁽²⁾ is NH₂(CH₂)₂NH(CH₂)₂NH(CH)₃-.

3. The coating system of claim 1, wherein
e) is at least one alcohol of formula CₙH₂ₙ₊₁OH, wherein n=1 to 4, or
is at least one selected from the group consisting of acetone and methyl ethyl ketone, or
is at least one acetate.

4. The coating system of claim 1, wherein at least one of components A and B further comprises
c) at least one reaction product of a further silane of formula (III) 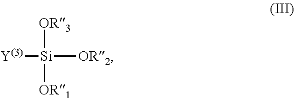
wherein
Y⁽³⁾ is alkyl-, fluoro-, fluoroalkyl-, methacryloyl-, vinyl-, or mercapto-, and
R″₁, R″₂, and R″₃ are identical or nonidentical alkyl groups having 1 to 6 carbon atoms.

5. A method for producing a surface coating on a substrate, the method comprising:
(i) combining components A and B of the coating system of claim 1, to give a first composition, and then
(ii) storing the first composition obtained in (i), to give a second composition, and then
(iii) applying the second composition obtained in (ii) to the substrate, and then
(iv) curing the substrate.

6. The method of claim 5, wherein in component A
Aa) is present with a weight fraction of 5% to 40% by weight, and
Ab) is present with a weight fraction of 5% to 20% by weight, and
Ac) is present with a weight fraction of 0.05% to 1% by weight,
and in component B
Ba) is present with a weight fraction of 5% to 50% by weight, and
Bb) is present with a weight fraction of 0.4% to 2% by weight,
and in at least one of components A and B
d) is present with a weight fraction of 2% to 20% by weight, and
e) is present with a weight fraction of 2% to 60% by weight,
each weight fraction being based on a total weight of the coating system, and with the proviso that the sum of the weight fractions taken together makes 100%.

7. The method of claim 6, wherein at least one of components A and B is admixed with c) with a weight fraction of 0.5% to 10% by weight, based on a total weight of the coating system, and with the proviso that the sum of the weight fractions taken together makes 100%.

8. The method of claim 5, wherein at least one of components A and B is admixed with,
f) at least one film-forming binder selected from the group consisting of a melamine resin and an acrylate, with a weight fraction of 0.001% to 15% by weight, and/or
g) epoxy resin with a weight fraction of 0.001% to 15% by weight,
each weight fraction being based on a total weight of the coating system, and with the proviso that the sum of the weight fractions taken together makes 100%.

9. The method of claim 5, wherein in (iv) the second composition is heated to a temperature of 60° C. to 150° C., as a result of which the second composition is cured.

10. The method of claim 5, wherein at least one of components A and B is admixed with,
h) at least one organic and/or inorganic UV absorber selected from the group consisting of zinc oxide, cerium oxide, and titanium dioxide
hydroxyphenylbenzotriazole, hydroxybenzophenone, and a HALS stabilizer
and in (iv) the second composition is treated with UV rays.

11. The method of claim 10, wherein h) is present with a weight fraction of 0.5% to 5% by weight, based on a total weight of the coating system, and with the proviso that a sum of the weight fractions taken together makes 100%.

12. A coating, comprising silicon-oxygen-silicon bonds and obtained by the method of claim 5.

13. The coating of claim 12, having a Weinmann scratch hardness of 5 N to 20 N.

14. The coating of claim 12, having an abrasion resistance of 0.1% to 0.5% by weight.

15. An article having at least one polymeric surface which comprises the coating of claim 12.

16. An apparatus, a fitting, an instrument, a measuring instrument, a sanitary installation, a kitchen appliance, a household appliance, a vehicle interior, a cockpit, a display, a viewing window, furniture, comprising the article of claim 15, or
a plate, a shell, a shaped part, a housing, a button, a lever, a foot, a door, a lid, a base, a side wall, a handle, a decorative insert or a splash-protection element as said article.

17. The coating system of claim 2, wherein at least one of components A and B further comprises
c) at least one reaction product of a further silane of formula (III) 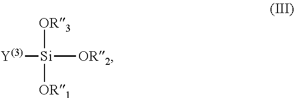
wherein
Y⁽³⁾ is alkyl-, fluoro-, fluoroalkyl-, methacryloyl-, vinyl-, or mercapto-, and
R″₁, R″₂, and R″₃ are identical or nonidentical alkyl groups having 1 to 6 carbon atoms.

18. The coating system of claim 3, wherein at least one of components A and B further comprises
c) at least one reaction product of a further silane of formula (III) 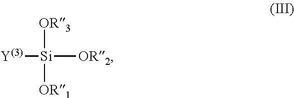
wherein
Y⁽³⁾ is alkyl-, fluoro-, fluoroalkyl-, methacryloyl-, vinyl-, or mercapto-, and R″₁, R″₂, and R″₃ are identical or nonidentical alkyl groups having 1 to 6 carbon atoms.
